(19) United States
(12) Patent Application Publication
(10) Pub. No.: US 2019/0035301 A1
(43) Pub. Date: Jan. 31, 2019

(54) PROVIDING VIABLE CAREER PATHS TO INDIVIDUALS

(71) Applicant: ADP, LLC, Roseland, NJ (US)

(72) Inventors: Jens Audenaert, New York, NY (US); Marina Mijatovic, Los Angeles, CA (US)

(21) Appl. No.: 15/658,536

(22) Filed: Jul. 25, 2017

(51) Int. Cl. G09B 19/00; G09B 7/02; G09B 5/00

(52) U.S. Cl. CPC G09B 19/00; G06Q 10/10; G09B 5/00; G09B 7/02

(57) ABSTRACT

A computer-implemented method, system and computer program product for providing viable career paths to people are provided. The computer-implemented method, system and computer program product use data collected on individuals to form a comprehensive profile of each of the individuals. The computer-implemented method, system and computer program product further enable a person to submit a profile. The computer-implemented method, system and computer program product then determine, using the submitted profile of the person, a plurality of individuals that have a comprehensive profile with similar attributes to the submitted profile of the person, generate a list of career fields in which the determined plurality of individuals are engaged, determine, using the generated list of career fields, paths used by the determined plurality of individuals to get into the career fields, and provide the determined paths as viable career paths to the person.

### BACKGROUND

### 1. Field

The present disclosure relates to helping a person make a career path decision, and more particularly, to a computer-implemented method, system and computer program product for providing viable career paths to an individual.

### 2. Description of the Related Art

In recent years, more and more companies have been using ethnographic research to gain a full understanding not only of their customers but also of their own business. Ethnography is a social science research method that involves embedding oneself deeply and over a long period of time in a field site of study in order to systemically document the everyday lives, behaviors, and interactions of a community of people. The goal of an ethnographer is to develop a rich understanding of how and why people think, behave, and interact as they do in a given community or organization from the standpoint of those who are being studied.

Companies that help employers find, hire, and manage talent (i.e., job recruitment companies) are also using ethnographic research to better understand today's workforce. According to an ethnographic research, most individuals stumble into jobs. More importantly, the research found that some individuals are in jobs about which they are not passionate although there are many other jobs about which they may be enthusiastic and that these jobs are not out of their reach. For example, a person with a Bachelor of Science (BS) degree in Psychology working in a customer service center may be ecstatic about event planning. Clearly, an event planning career is not out of reach of such person. However, because the person may not know how to transition from the customer service position to an event planning position, the person may think that such career is out of reach Likewise, becoming a nurse (or anything else for that matter) is not out of reach of a person working at a Police Academy. Thus, so long as a person figures out the path that they need to take to transition from one career to a more desirable one, the person may not think that the desirable career is out of reach.

Therefore, there is a need for a system and method that provide individuals a path that the individuals may take to transition from one career field about which they do not have much enthusiasm to one about which they are rather passionate.

### SUMMARY

A computer-implemented method, system and computer program product for providing viable career paths to a person are provided. The computer-implemented method, system and computer program product use data collected on individuals to form a comprehensive profile of each of the individuals. The computer-implemented method, system and computer program product further enable a person to submit a profile. The computer-implemented method, system and computer program product then determine, using the submitted profile of the person, a plurality of individuals that have a comprehensive profile with similar attributes to the submitted profile of the person and generate a list of career fields in which the determined plurality of individuals are engaged. The computer-implemented method, system and computer program product determine, using the generated list of career fields, paths used by the determined plurality of individuals to get into the career fields and provide the determined paths as viable career paths to the person.

In one embodiment, one of the similar attributes includes a skill set. In another embodiment, one of the similar attributes includes experience gained from a previous employment. In yet further embodiment, one of the similar attributes includes a university degree and/or a work history.

In a particular embodiment, the profile submitted by the person includes a psychometric evaluation and/or a career assessment test, wherein the psychometric evaluation and/or career assessment test is used to determine a path or an environment in which the person is likely to thrive.

### BRIEF DESCRIPTION OF THE DRAWINGS

FIG. 1 is an illustration of a pictorial representation of a network of data processing systems in which the present invention may be implemented;

FIG. 2 is an illustration of a block diagram of a data processing system that may be implemented as a server, which may be used to help employers find, hire and manage talent in accordance with an illustrative embodiment;

FIG. 3 is an illustration of a block diagram illustrating a data processing system in accordance with an illustrative embodiment;

FIG. 4 is an illustration of a flowchart of a process that may be used by a career path seeker to submit a profile to a job recruiting company in accordance with an illustrative embodiment;

FIG. 5 is an illustration of a flowchart of a process that may be used by a job recruiting company to provide viable career paths to a career path seeker in accordance with an illustrative embodiment; and

FIG. 6 is an illustration of a block diagram of a data processing system in accordance with an illustrative embodiment.

### DETAILED DESCRIPTION

In accordance with the present disclosure, the present invention provides an improvement over conventional methods of choosing a career path. For example, conventional methods of choosing a career path include taking career assessment tests. Career assessment tests include online quizzes or career aptitude tests that may help a person determine potential occupations and corresponding work environments that the person may excel at based on the person's personality type. Other conventional methods of choosing a career path include hiring career coaches. Career coaches are individuals who are generally masters at networking and can often access resources that a person may not find without their help. Using those resources, career coaches may help people connect with careers that they may love. Some further conventional methods of choosing a career path include interviewing certain types of people. These people may include a supervisor, a professor, or someone the person already knows that is working in a field in which the person is interested.

According to the present invention, data may be collected about individuals at large. The data may include a work history of the individuals, schools and/or universities attended, degrees conferred, documents, qualifications, school and/or university transcripts, professional licenses, skill sets, compensation records, geographical locations where the individuals live, and other records of the individuals. The data may then be used to help a person make sound career decisions, plan his/her career as well as discover viable career paths.

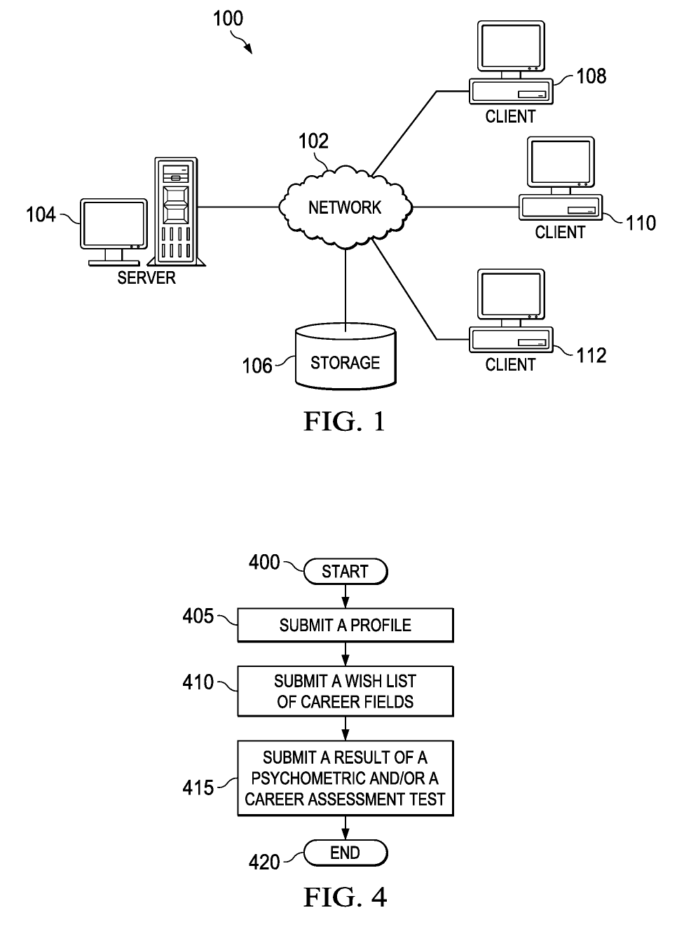

With reference now to the figures, FIG. 1 is an illustration of a pictorial representation of a network of data processing systems in which the present invention may be implemented. Network data processing system 100 is a network of computers that contains network 102, which is the medium used to provide communications links between various devices and computers connected together within network data processing system 100. Network 102 may include connections, such as wire, wireless communication links, fiber optic cables, or other suitable types of connections.

In the depicted example, server 104 is connected to network 102 along with storage 106. In addition, clients 108, 110, and 112 are connected to network 102. Clients 108, 110, and 112 may be, for example, personal computers or network computers. In the depicted example, server 104 may provide data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

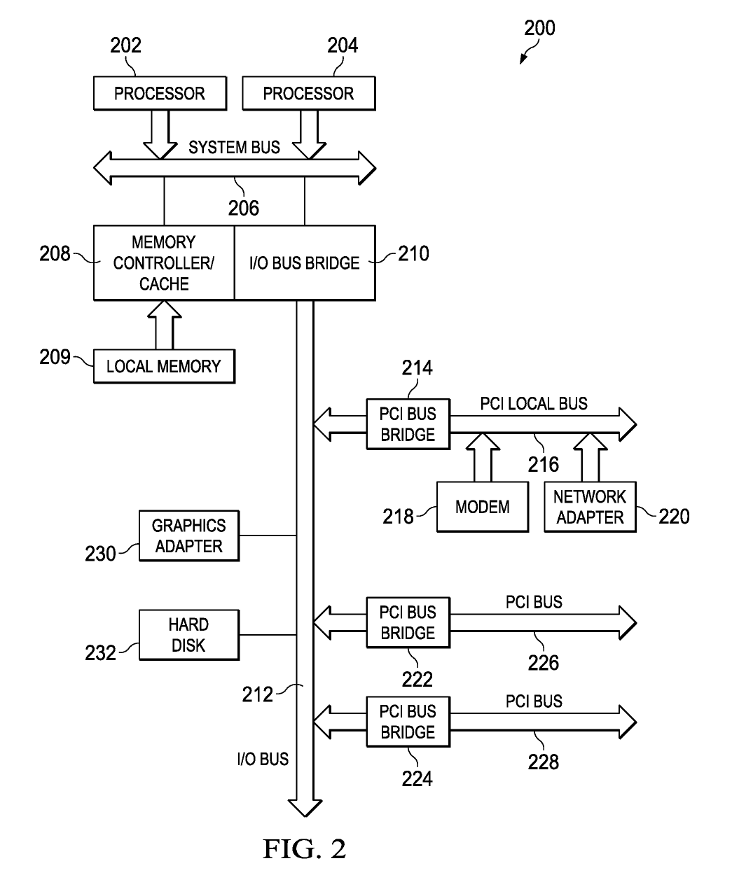

Referring to FIG. 2, a block diagram of a data processing system that may be implemented as a server, which may be used to help employers find, hire and manage talent is depicted in accordance with an illustrative embodiment. Data processing system 200 may be a symmetric multiprocessor (SMP) system including a plurality of processors, including processor 202 and processor 204 connected to system bus 206. Alternatively, more or a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214, connected to I/O bus 212, provides an interface to PCI local bus 216. A number of modems may be connected to PCI local bus 216. Typical PCI bus implementations will support four PCI expansion slots or add-in connectors. Communications links to server 104, shown in FIG. 1, or to other computer systems (not shown) in FIG. 1 may be provided through modem 218 and network adapter 220 connected to PCI local bus 216 through add-in boards.

Additional PCI bus bridges, such as PCI bus bridge 222 and PCI bus bridge 224, provide interfaces for additional PCI local bus 226 and PCI local bus 228, from which additional modems or network adapters may be supported. In this manner, data processing system 200 allows connections to multiple computer systems. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives, universal serial bus (USB) drives and the like, also may be used, in addition to or in place of, the hardware depicted. Thus, the depicted example is not meant to imply architectural limitations.

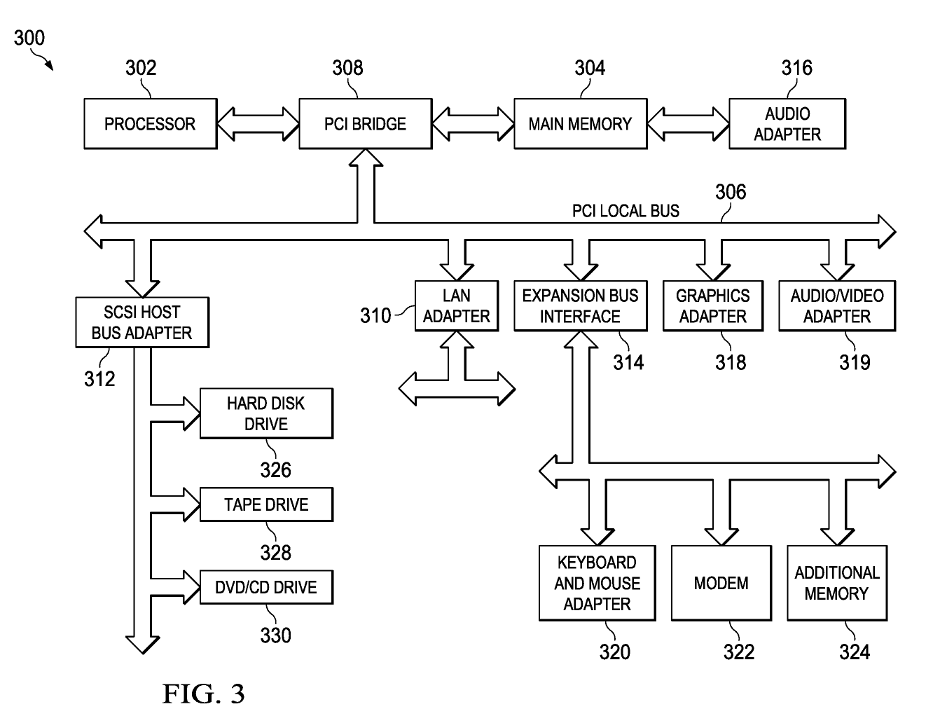

With reference now to FIG. 3, a block diagram illustrating a data processing system is depicted in accordance with an illustrative embodiment. Data processing system 300 is an example of a client computer, such as server 104 of FIG. 1. Data processing system 300 employs a peripheral component interconnect (PCI) local bus architecture. Although the depicted example employs a PCI bus, other bus architectures such as accelerated graphics port (AGP) and industry standard architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by a direct component connection. In contrast, audio adapter 316, graphics adapter 318, and audio/video adapter 319 are connected to PCI local bus 306 by add-in boards inserted into expansion slots. Expansion bus interface 314 provides a connection for keyboard and mouse adapter 320, modem 322, and additional memory 324. Small computer system interface (SCSI) host bus adapter 312 provides a connection for hard disk drive 326, tape drive 328, and DVD/CD drive 330. Typical PCI local bus implementations will support three or four PCI expansion slots or add-in connectors.

An operating system runs on processor 302 and is used to coordinate and provide control of various components within data processing system 300 in FIG. 3. The operating system may be an open source operating system, such as Linux, or a Microsoft Windows® operating system or the like. Microsoft Windows® is a trademark of the Microsoft Corporation. An object oriented programming system, such as Java, may run in conjunction with the operating system and provide calls to the operating system from Java programs or applications executing on data processing system 300. Java is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary, depending on the implementation. Other internal hardware or peripheral devices, such as flash ROM (or an equivalent nonvolatile memory) or optical disk drives, USB drives and the like, may be used in addition to or in place of the hardware depicted in FIG. 3. Also, the processes of the present disclosure may be applied to a multiprocessor data processing system.

The depicted example in FIG. 3 and above-described examples are not meant to imply architectural limitations. For example, data processing system 300 may also be a mobile device such as a personal digital assistant (PDA) device, a cellular telephone, a tablet, a notebook, a laptop and other suitable types of devices. Data processing system 300 also may be a kiosk or a Web appliance.

Generally, job recruiting companies (i.e., companies that match job seekers to employers) have job seekers' resumes. The resumes usually include the work history of the job seekers, schools and/or universities attended, degrees conferred, or other suitable types of information about a job seeker. Furthermore, some of these companies may perform services for employers. The services may include human resources (HR) services such as maintaining benefits, documents, qualifications, school and/or university's transcripts, professional licenses, skill sets, payroll records and other records of the employees. Some of these companies may even process employers' payrolls to generate paychecks for employees.

Consequently, these companies may have in their possession a lot of information or data on individuals based on the services provided to the individuals (e.g., when the individuals were seeking employment using the companies' services) and/or based on services provided and/or being provided to the individuals' employers. Analysis of the data may indicate that a group of individuals (e.g., individuals in a certain career field) is located in a particular geographical area. For example, individuals in the high-tech industry may be found to be concentrated in Silicon Valley or that federal government employees are in Washington, D.C. Upon determining that those individuals are concentrated in a particular area, the companies may do research to determine the reason why the individuals are concentrated in that particular area. One reason that the companies may find is that the area provides societal or structural support for the particular career field. For example, there may be lots of good paying jobs in that area for anyone in that field or that there are universities, research facilities or other types of institutions that cater to individuals in that field.

Analysis of the data may also indicate qualifications that may help a person enter a career field, as well as jobs that may require similar skills and qualifications. The analysis may further indicate the skills and abilities needed to progress within a particular career field and/or career paths that may ultimately lead to particular positions in particular career fields.

A job recruiting company may use the data to generate a comprehensive profile of each of these individuals. Each individual's comprehensive profile may include schools and/or universities attended, degrees conferred, a work history including a career path, a compensation history, professional licenses, skill sets, a geographical location of the individual and/or any information that is at the disposal of the companies and that the companies deem important.

A job recruiting company may then use the data or the information gleaned from the data to help a person make sound career decisions, plan his/her career, as well as discover viable career paths. In such a case, the job recruiting company may first request that the person submit a profile. The profile may include schools and/or universities attended, degrees conferred, a work history, a compensation history, professional licenses, skill sets, desired geographical locations or other suitable types of information about the job seeker. The job recruiting company may also request that the person submit a wish list of careers in which the person may be interested (i.e., career fields about which the person may be passionate).

Further, the job recruiting company may suggest that the person take a psychometric and/or a career assessment test. A psychometric test is used to measure a person's suitability for a role based on required personality characteristics and aptitude for the role. Thus, a psychometric test may identify the extent to which a person's personality and cognitive abilities match those required to perform a role. By contrast, a career assessment test can give a person insights into the person's career personality. That is, based on a characterization of the person's personality, the person may learn the type of work environments and occupations that best suit the person. The result of a career assessment test, then, may provide a person with a list of professions and occupations that best fit the person's career personality.

Using the profile submitted by the person along with a wish list and the result of the psychometric and/or the career assessment test, the job recruiting company may determine individuals with comprehensive profiles similar to that of the person seeking a particular type of job. As alluded to above, an individual's comprehensive profile may indicate qualifications that help the individual enter a career field, skills and abilities that were instrumental for the individual to progress within the career field, or a path that led the individual to the career field.

Thus, using the comprehensive profile of the determined individuals (i.e., career fields in the profiles of the individuals), the job recruiting company may generate a list of career fields that the determined individuals are engaged in and in which the person may also engage. This list may be compared to the person's wish list of career fields to determine whether any career field in the wish list is in the generated list of career fields. If so, then the job recruiting company may, for each of the common career fields (career fields that are in both the wish list and the generated list), determine the paths that the determined individuals had taken to end up in their career fields, the skills and abilities used by the determined individuals to succeed in the career fields, or the geographical areas where the determined individuals are located. The job recruiting company may then present the information to the person to help the person make sound career decisions, plan his/her career as well as discover viable career paths (i.e., the career paths taken by the determined individuals in the comprehensive profile).

Returning to FIG. 1, server 104 may represent a job recruiting company. Consequently, the information on the individuals (not shown) may be located on server 104. Server 104 may also have a section available for career path seekers. While on the board, a career path seeker has access only to information pertaining to the career path seeker. In order for a career path seeker at client 108, 110 or 112, for example, to access the section on server 104 that is dedicated to career path seekers, the career path seeker must present proper credentials to log onto that section of server 104. Once there, the career path seeker may submit, or update the career path seeker's profile or career path wish list.

In addition, the job recruiting company may suggest that the career path seeker take a psychometric and/or a career assessment test. These tests may provide the job recruiting company with more data with which to accurately and effectively provide viable career paths to the career path seeker.

Further, server 104 may have different algorithms to collect data on individuals. As mentioned before, the data may already be on server 104 or on other systems (not shown) affiliated with the job recruiting company. The algorithms may be used to parse the collected data for all sorts of information including skill sets, career fields, career paths that led to particular career fields, abilities, a work history, university degrees or other suitable types of information. The data may also be used to generate comprehensive profiles on the individuals whose data is being parsed. The comprehensive profiles may be used to generate viable career paths that may be provided to career path seekers.

FIG. 4 is an illustration of a flowchart of a process that may be used by a career path seeker to submit a profile to a job recruiting company in accordance with an illustrative embodiment. The process starts at block 400 when the career path seeker logs onto server 104 of FIG. 1 to submit or update a profile. The career path seeker may submit the profile (block 405). The career path seeker may then submit a wish list of career fields about which the career path seeker may be passionate (block 410). While there, the career path seeker may submit a result of any test that the career path seeker may have taken to help with making career path decisions. For example, the result of the test(s) may be submitted if the career path seeker has taken a psychometric test and/or a career assessment test (block 415). The process ends with the career path seeker logging off server 104 (block 420).

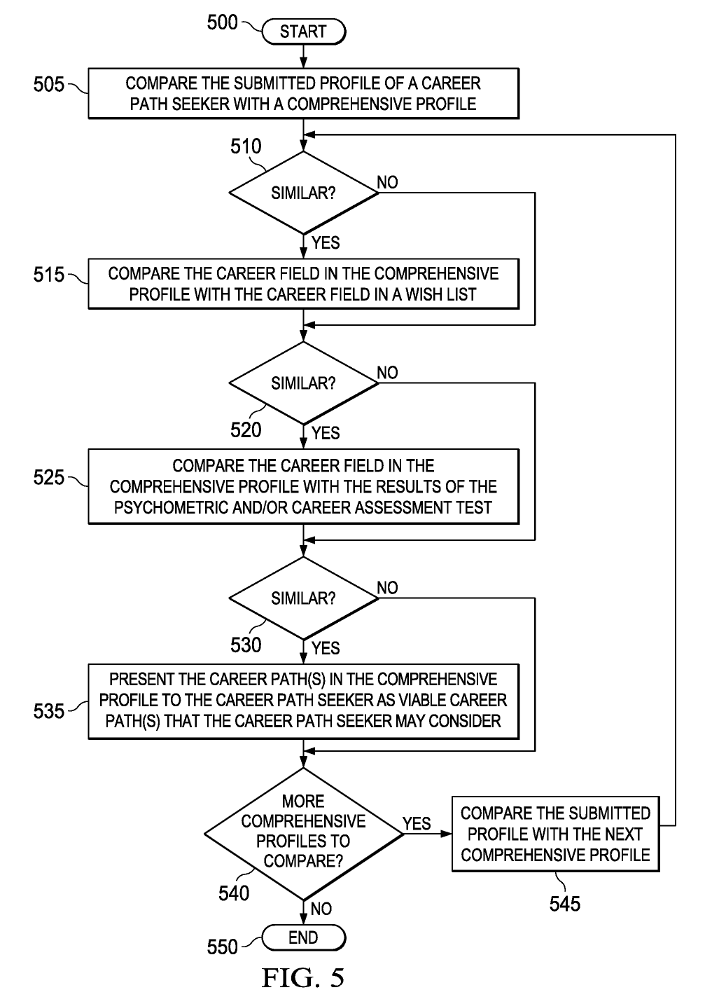

FIG. 5 is an illustration of a flowchart of a process that may be used by a job recruiting company to provide viable career paths to a career path seeker in accordance with an illustrative embodiment. The process starts at block 500 where on a periodic basis or after a career path seeker has submitted a profile, wish list and results of optional tests taken to help with making career field/path decisions, the submitted profile is compared with comprehensive profiles that might have been generated using data collected on individuals at large. For each comprehensive profile generated for an individual, the process compares the submitted profile of the career path seeker with the comprehensive profile (block 505). The process determines whether there are any similarities between the two profiles (block 510). Similarities may include university degrees, same skill sets, same abilities, same career fields, career field paths, and/or work histories. If there is not any similarity between the two profiles, the process goes on to block 520. If there is at least one similarity, the career field(s) in the comprehensive profile is compared to the career fields in a wish list of the career path seeker (block 515). A determination is made as to whether there are any similarities between the career fields in the comprehensive profile and the wish list (block 520). If there is not any similarity between the career field(s) in the comprehensive profile and the career fields in the wish list, the process goes on to block 530. If there is at least one similarity, the career field in the comprehensive profile is compared with the results of the psychometric and/or career assessment test if any was submitted by the career path seeker (block 525). A determination is made as to whether there is any similarity between the career field in the comprehensive profile and the results of the psychometric and/or career assessment test (block 530). If there is not any similarity between the career field in the comprehensive profile and the results of the psychometric and/or career assessment test, the process goes on to block 540. If there is at least one similarity, the career path(s) taken by the individual whose comprehensive profile was used will be presented to the career path seeker as one viable career path(s) that the career path seeker may consider (block 535). At this point, a check may be made to determine whether there are more comprehensive profiles with which to compare the submitted profile (block 540). If so, the process goes on to compare the submitted profile with the next comprehensive profile (block 545). If not, the process ends (block 550).

Note that the process shown in FIG. 5 is not restricted to the sequence delineated above. For example, in other sequences the profile generated for an individual may first be compared with the wish list of the career path seeker instead of with the submitted profile of the career path seeker. Hence, the sequence delineated above is only for illustrative purposes.

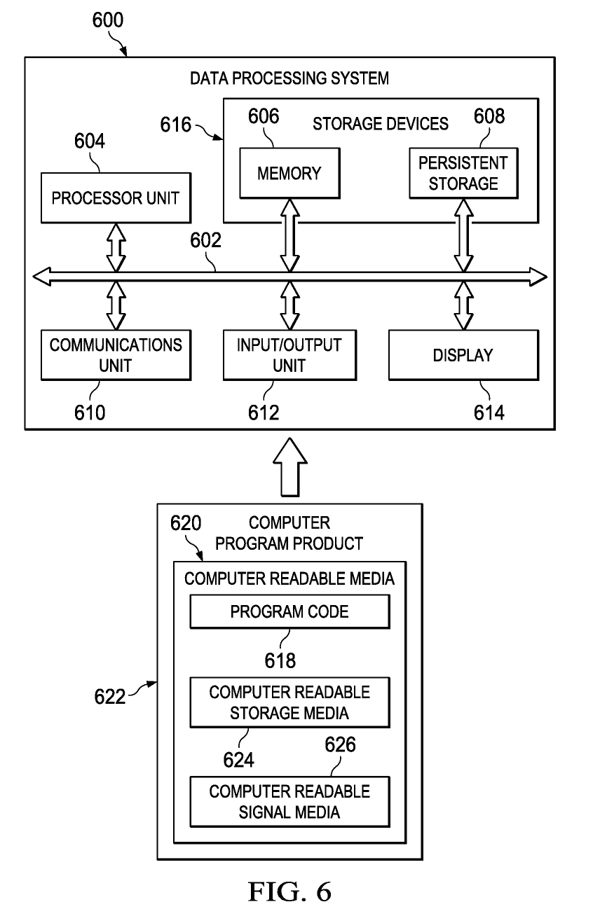

Turning now to FIG. 6, an illustration of a block diagram of a data processing system is depicted in accordance with an illustrative embodiment. Data processing system 600 is a more explicit implementation of server 104 of FIG. 1. In this illustrative example, data processing system 600 includes communications framework 602, which provides communications between processor unit 604, memory 606, persistent storage 608, communications unit 610, input/output unit 612, and display 614. In this example, communications framework 602 may take the form of a bus system.

Processor unit 604 serves to execute instructions for software that may be loaded into memory 606. Processor unit 604 may be a number of processors, a multi-processor core, or some other type of processor, depending on the particular implementation.

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer-readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. In an illustrative embodiment, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer usable program code, or computer readable program code that may be read and executed by a processor in processor unit 604. The program code in the different embodiments may be embodied on different physical or computer-readable storage media, such as memory 606 or persistent storage 608.

Program code 618 is located in a functional form on computer-readable media 620 that is selectively removable and may be loaded onto or transferred to data processing system 600 for execution by processor unit 604. Program code 618 and computer-readable media 620 form computer program product 622 in these illustrative examples. In one example, computer-readable media 620 may be computer-readable storage media 624 or computer-readable signal media 626.

In these illustrative examples, computer-readable storage media 624 is a physical or tangible storage device used to store program code 618 rather than a medium that propagates or transmits program code 618. Alternatively, program code 618 may be transferred to data processing system 600 using computer-readable signal media 626. Computer-readable signal media 626 may be, for example, a propagated data signal containing program code 618. For example, computer-readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of providing viable career paths to a person comprising:
using data collected on individuals to form a comprehensive profile of each of the individuals;
enabling the person to submit a profile;
determining, using the submitted profile of the person, a plurality of individuals that have a comprehensive profile that has similar attributes to the submitted profile of the person;
generating a list of career fields in which the determined plurality of individuals are engaged;
determining, using the generated list of career fields, paths used by the determined plurality of individuals to get into the career fields; and
providing the determined paths as viable career paths to the person.

2. The method of claim 1, wherein one of the similar attributes includes a skill set.

3. The method of claim 1, wherein one of the similar attributes includes experience gained from a previous employment.

4. The method of claim 1, wherein one of the similar attributes includes a university degree.

5. The method of claim 1, wherein one of the similar attributes includes a work history.

6. The method of claim 1, wherein the submitted profile of the person includes a psychometric evaluation of the person, wherein the psychometric evaluation is used to determine a path or an environment in which the person is likely to thrive.

7. The method of claim 6, wherein the generated list of career fields includes careers that are in the determined environment.

8. The method of claim 1, wherein the generated list of career fields includes geographical locations in which the determined individuals are located.

9. The method of claim 8, wherein the geographical locations include locations having societal structures that support careers in the generated list of career fields.

10. A computing system for providing viable career paths to a person comprising:
at least one storage device for storing program code; and
at least one processor for processing the program code to:
use data collected on individuals to form a comprehensive profile of each of the individuals;
enable the person to submit a profile;
determine, using the submitted profile of the person, a plurality of individuals that have a comprehensive profile with similar attributes to the submitted profile of the person;
generate a list of career fields in which the determined plurality of individuals are engaged;
determine, using the generated list of career fields, paths used by the determined plurality of individuals to get into the career fields; and
provide the determined paths as viable career paths to the person.

11. The computing system of claim 10, wherein one of the similar attributes includes a skill set.

12. The computing system of claim 10, wherein one of the similar attributes includes experience gained from a previous employment.

13. The computing system of claim 12, wherein one of the similar attributes includes a work history.

14. The computing system of claim 10, wherein the submitted profile of the person includes a psychometric evaluation of the person, wherein the psychometric evaluation is used to determine a path or an environment in which the person is likely to thrive.

15. A computer program product for providing viable career paths to a person, the computer program product comprising:
a computer-readable storage medium having computer-readable program code embodied therewith for execution on a computing system, the computer-readable program code comprising computer-readable program code configured to:
use data collected on individuals to form a comprehensive profile of each of the individuals;
enable the person to submit a profile;
determine, using the submitted profile of the individual, a plurality of individuals that have a comprehensive profile with similar attributes to the submitted profile of the person;
generate a list of career fields in which the determined plurality of individuals are engaged;
determine, using the generated list of career fields, paths used by the determined plurality of individuals to get into the career fields; and
provide the determined paths as viable career paths to the person.

16. The computer program product of claim 15, wherein one of the similar attributes includes a skill set.

17. The computer program product of claim 15, wherein one of the similar attributes includes experience gained from a previous employment.

18. The computer program product of claim 15, wherein one of the similar attributes includes a university degree.

19. The computer program product of claim 15, wherein one of the similar attributes includes a work history.

20. The computer program product of claim 15, wherein the submitted profile of the person includes a psychometric evaluation of the person, wherein the psychometric evaluation is used to determine a path or an environment in which the person is likely to thrive.
